(19) United States
(12) Patent Application Publication
(10) Pub. No.: US 2012/0254270 A1
(43) Pub. Date: Oct. 4, 2012

(54) DATA MANAGEMENT APPARATUS, DATA MANAGEMENT METHOD, AND COMPUTER PROGRAM PRODUCT

(75) Inventor: Takashi ISHIDOSHIRO, Nagoya-shi (JP)

(73) Assignee: BUFFALO INC., Nagoya-shi (JP)

(21) Appl. No.: 13/435,971

(22) Filed: Mar. 30, 2012

(30) Foreign Application Priority Data
Mar. 30, 2011 (JP) 2011-074914

(51) Int. Cl. G06F 17/30

(52) U.S. Cl. 707/827; 707/E17.01

(57) ABSTRACT

A data management apparatus, method and computer program product use a communication unit that communicates with a plurality of online storage systems. At least one of the plurality of online storage systems is selected to save data to later be saved in the selected online storage. A Save location information is saved, and the save location information has information for identifying the data saved by the saving unit associated with information for identifying the online storage. A reading unit refers to the save location information stored in the save location storage unit in response to a read request of data and specifies the online storage that has the target data of the read request to read the target data of the read request from the specified online storage.

### CROSS REFERENCE TO RELATED APPLICATION

The present application claims priority to Japanese Patent Application No. 2011-074914, the disclosure of which is hereby incorporated by reference in its entirety.

### BACKGROUND

1. Field

The present disclosure relates to a data management apparatus, data management method and data management computer program product for using online storage systems.

2. Description of the Related Art

In recent years, along with the development of communication techniques, not only in a storage device (for example, a hard disk drive, HDD) provided in a terminal device of a user, but also an online storage service has been used, in which data is saved in storage devices provided on the Internet (called “online storage systems” or “online storage systems”).

In the online storage service, storage areas of the online storage systems are allocated to each registered user. The user can log into the online storage systems to save or read data in the allocated storage areas.

A method is proposed as a technique for improving the convenience of the online storage service, in which an application, a user ID, and a password used in the online storage service are recorded in a removable storage device, and the user can comfortably use the online storage service at any location away from home (Japanese Patent Laid-Open No. 2004-126908).

If the online storage service is further widely used, the number of users who use a plurality of online storage systems is considered to increase.

The online storage systems, however, may be different from each other in data formats that can be saved in differing available storage capacities. Therefore, when a user intends to use more than one online storage, the user needs to know the data formats that can be saved and the available capacities for each of the online storage systems, which is burdensome for the user. It is also burdensome for the user to manage the security, such as login control, for each of the online storage systems. The user also needs to keep in mind which data is saved in which online storage, or otherwise the user needs to look for the saved data in a plurality of online storage. storage systems

### SUMMARY

One aspect of the present disclosure is to provide a data management apparatus, method and computer program product that can improve the convenience of a user who uses a plurality of online storage systems and that can reduce the management burden of the user.

Accordingly, an exemplary data management apparatus is described that includes a communication unit in communication with a plurality of online storage systems; a saving unit selecting at least one of the plurality of online storage systems and that saves data to be saved in the selected online storage; a save location storage unit storing save location information, the save location information having information for identifying the data saved by the saving unit associated with information for identifying the online storage; and a reading unit referring to the save location information stored in the save location storage unit in response to a read request of data and specifies the online storage that has the target data of the read request to read the target data of the read request from the specified online storage.

### BRIEF DESCRIPTION OF THE DRAWINGS

FIG. 1 is a diagram showing a configuration of a data management system according to an embodiment;

FIG. 2 is a block diagram showing a configuration of a NAS as a data management apparatus according to an embodiment;

FIG. 3 is a diagram showing a configuration of online storage information of an embodiment;

FIG. 4 is a diagram showing a configuration of save location information of an embodiment;

FIG. 5 is a flow chart showing an operation of data saving to an online storage of an embodiment;

FIG. 6 is a flow chart showing an operation of data reading from an online storage of an embodiment;

FIG. 7 is a diagram showing a configuration of the data management system according to another aspect of the embodiment; and

FIG. 8 is a block diagram showing a configuration of a gateway as a data management apparatus according to an embodiment.

### DETAILED DESCRIPTION

Embodiments will be described with reference to the drawings. In the following drawings of the embodiments, like or similar elements are designated with the same reference numerals.

In a first aspect of the exemplary embodiments, a Network Attached Storage (NAS) serves as the data management apparatus.

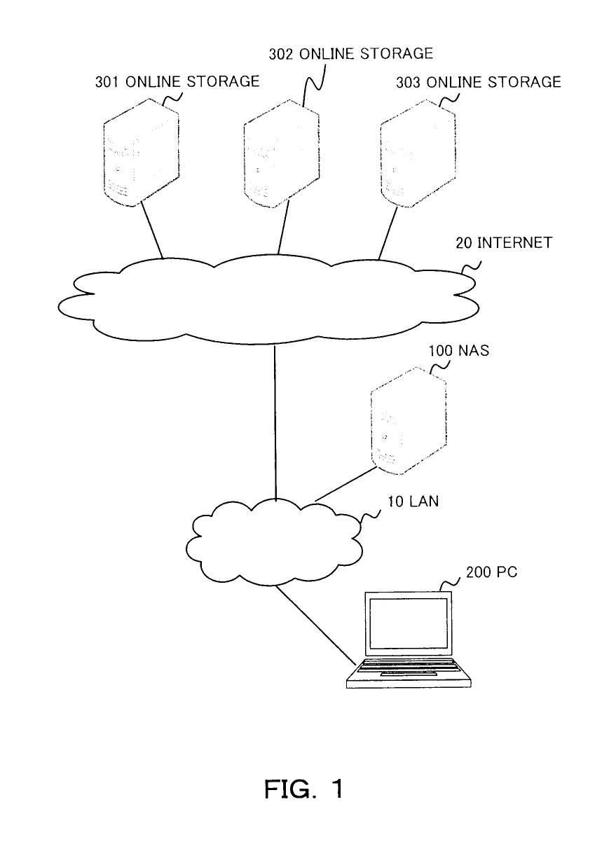

FIG. 1 is a diagram showing a configuration of a data management system according to the first aspect.

As shown in FIG. 1, the data management system according to the first aspect includes a NAS 100, a personal computer (PC) 200, and a plurality of online storage systems 301 to 303.

The NAS 100 and the PC 200 are connected to a local area network (LAN) 10, such as an in-house network, through cables. In the present aspect, the NAS 100 corresponds to the data management apparatus, and the PC 200 corresponds to the terminal device. The LAN 10 is connected to Internet 20 via a router, etc., through a cable. The plurality of online storage systems 301 to 303 are connected to the Internet 20 via cables.

Here, it is supposed that some of the allowable data formats of the plurality of online storage systems 301 to 303 are the same, and some are different. The user of the PC 200 holds membership in the plurality of online storage systems 301 to 303, and each of the plurality of online storage systems 301 to 303 has own storage areas allocated.

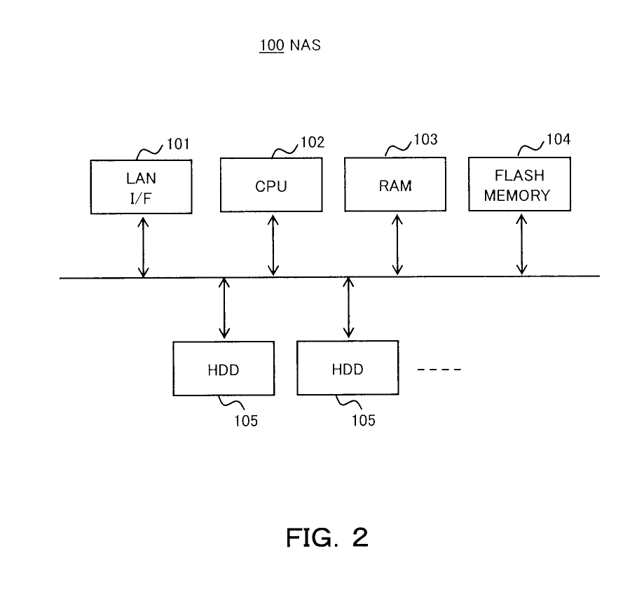

FIG. 2 is a block diagram showing a configuration of the NAS 100.

As shown in FIG. 2, the NAS 100 includes a LAN interface (I/F) 101, a central processing unit (CPU) 102, a memory 103, a flash memory 104, and a plurality of hard disk drives (HDDs) 105.

When data for the NAS 100 is received through the LAN 10, the LAN I/F 101 outputs the received data to the CPU 102. In accordance with an instruction input from the CPU 102, the LAN I/F 101 transmits designated data to a designated address via the LAN 10. In the present aspect, the LAN I/F 101 corresponds to the communication unit that communicates with the plurality of online storage systems 301 to 303 and the PC 200.

The CPU 102 executes programs stored in the memory 103. When a data save request is received from the PC 200, the CPU 102 executes a process of saving the data in one of the plurality of online storage systems 301 to 303. When a data read request is received from the PC 200, the CPU 102 executes a process of reading the data from one of the plurality of online storage systems 301 to 303. Therefore, the CPU 102 corresponds to the saving unit and the reading unit.

The memory 103 is, for example, a RAM (Random Access Memory) and temporarily stores a program executed by the CPU 102. The program is read out from, for example, the flash memory 104. The memory 103 is also used as a work memory of the CPU 102. The flash memory 104 stores programs executed by the CPU 102. The programs may be stored and provided in a computer-readable recording medium, such as a DVD-ROM (Digital Versatile Read Only Memory), and stored in the flash memory 104. The plurality of HDDs 105 store various pieces of information and form a disk array. The HDDs 105 may form RAID (Redundant Arrays of Inexpensive Disks).

In the present aspect, the flash memory 104 stores information related to the online storage systems.

In the present aspect, the flash memory 104 corresponds to a data format storage unit that stores data format information indicating allowable data formats for each of the plurality of online storage systems, to a login information storage unit that stores login information including user IDs and passwords for each of the plurality of online storage systems, and to an upper capacity information storage unit that stores upper capacity information indicating an upper limit of the storage capacity for each of the plurality of online storage systems.

The information may not be necessarily stored in the flash memory 104, and the information may be stored in one of the plurality of HDDs 105.

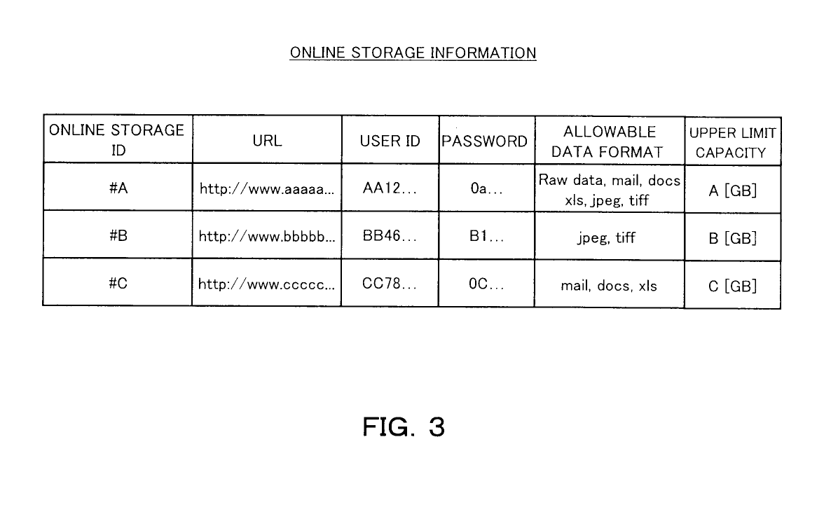

FIG. 3 is a diagram showing an example of content of online storage information stored in the flash memory 104 in the present aspect. As shown in FIG. 3, the online storage information includes information for identifying the online storage systems (online storage IDs), network addresses of the online storage systems (may be URLs), login information (user IDs as information for identifying the users and passwords), allowable data format information with a list of data formats that can be stored, and upper capacity information defining upper limits of the capacities of the data that can be stored, all of which are associated with each other. The CPU 102 manages and updates the online storage information.

The online storage 301 shown in FIG. 1 permits saving in data formats of Raw data, mail data, docs data, xls data, jpeg data, and tiff data. In the example shown in FIG. 3, the online storage ID is “#A”, the URL is “http://www.aaaaa . . . ”, the user ID is “AA12 . . . ”, the password is “0a . . . ”, the allowable data format is “Raw data, mail, docs, xls, jpeg, tiff”, and the upper capacity is “A [GB]”.

The online storage 302 shown in FIG. 1 permits saving in data formats of jpeg data and tiff data. In the example shown in FIG. 3, the online storage ID is “#B”, the URL is “http://www.bbbbb . . . ”, the user ID is “BB46 . . . ”, the password is “B1 . . . ”, the allowable data format is “jpeg, tiff”, and the upper capacity is “B [GB]”.

The online storage 303 shown in FIG. 1 permits saving in data formats of mail data, docs data, and xls data. In the example shown in FIG. 3, the online storage ID is “#C”, the URL is “http://www.ccccc . . . ”, the user ID is “CC78 . . . ”, the password is “0C . . . ”, the allowable data format is “mail, docs, xls”, and the upper capacity is “C [GB]”.

In the present aspect, the CPU 102 further associates information for identifying data stored by the user in one of the online storage systems with information for identifying the online storage as a storage location, and the flash memory 104 holds the information. Therefore, the flash memory 104 corresponds to the save location storage unit that stores save location information indicating an association between the saved data and the online storage as a save location of the data. However, the arrangement is not limited to this, and the CPU 102 may store the save location information in one of the plurality of HDDs 105.

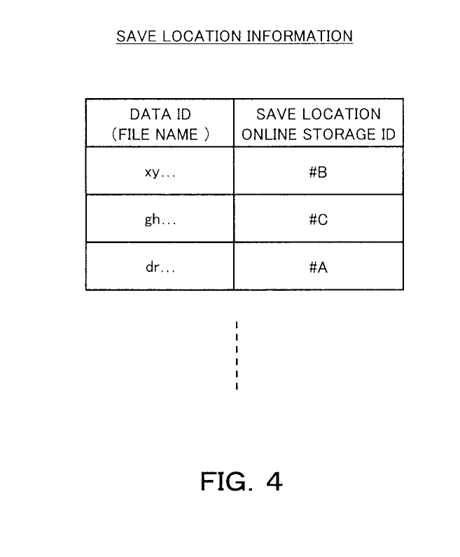

FIG. 4 is a diagram showing an example of content of the save location information stored in the flash memory 104. As described, the CPU 102 manages and updates the save location information.

As shown in FIG. 4, when data is saved in an online storage in accordance with an instruction of the user, the CPU 102 associates information for identifying the data (for example, may be the file name) with information for identifying the online storage as a save location of the data (may be the online storage ID) and stores the information in the flash memory 104 as the save location information.

In the example shown in FIG. 4, the online storage as a save location of data “xy . . . ” is “#B” (online storage 302), the online storage as a save location of data “gh . . . ” is “#C” (online storage 303), and the online storage as a save location of data “dr . . . ” is “#A” (online storage 301).

An operation of the CPU 102 of the NAS 100 with the configuration will be described. The CPU 102 receives a data save request from the PC 200. The CPU 102 then selects one of the plurality of online storage systems 301 to 303 and saves, in the selected online storage, the data to be saved accepted by the PC 200. The CPU 102 generates save location information indicating an association between the saved data and the online storage as a save location of the data and stores the save location information in the flash memory 104.

When a data read request is received from the PC 200, the CPU 102 reads the save location information from the flash memory 104. The CPU 102 refers to the read save location information to specify the online storage that has the data requested from the PC 200 and reads the data from the specified online storage. The CPU 102 transmits the read data to the PC 200 as a request source.

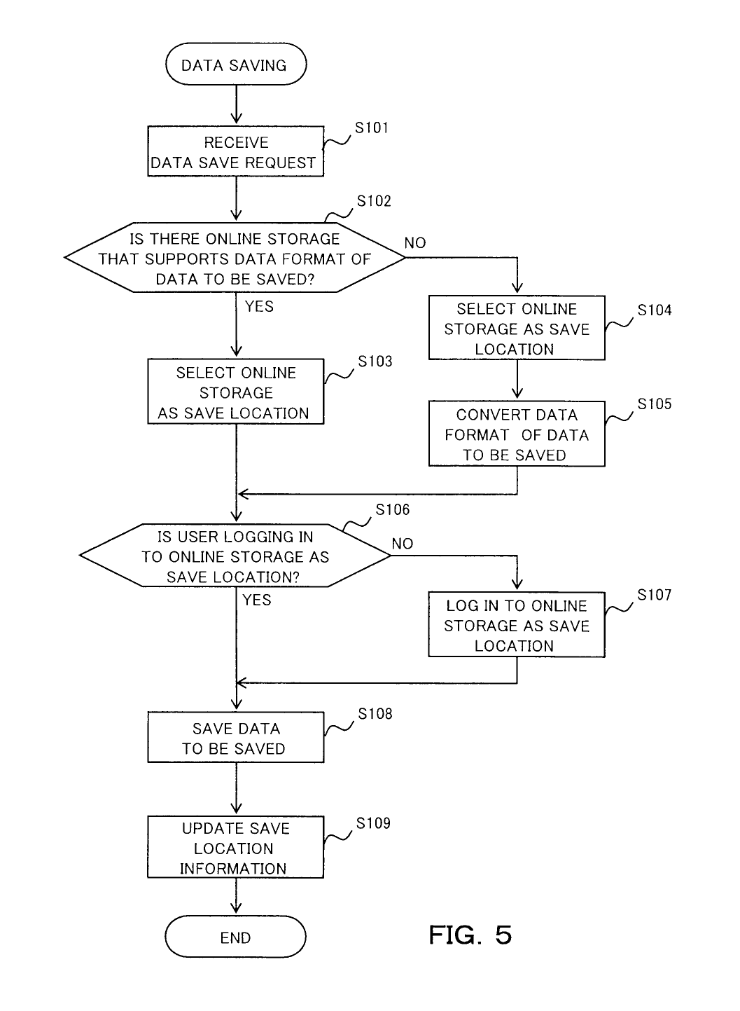

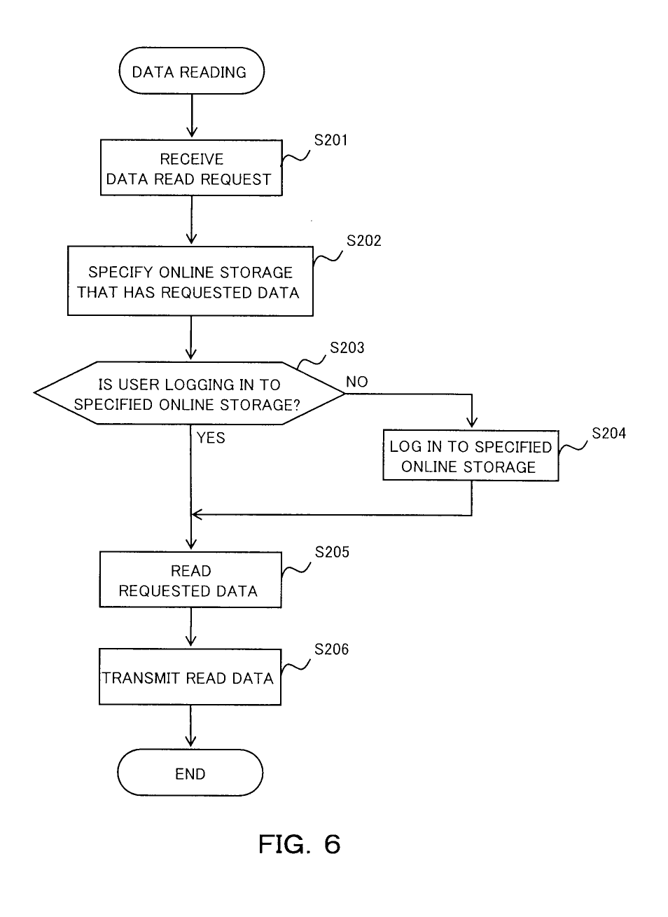

Specific operations of the NAS 100 as a data management apparatus will be described with reference to FIGS. 5 and 6. An operation of data saving to an online storage and an operation of data reading from an online storage will be described in this order.

FIG. 5 is a flow chart showing an operation of the NAS 100 as a data management apparatus in data saving to an online storage.

As shown in FIG. 5, the LAN I/F 101 receives a data save request from the PC 200 in step S101. The data save request includes data to be saved (save target data) and information for identifying the save target data (for example, file name). The CPU 102 accepts the data save request from the LAN I/F 101 and temporarily stores the save target data included in the data save request in the RAM 103.

In step S102, the CPU 102 determines the data format of the save target data. The data format may be determined based on an extension (such as .doc and .pdf) included in the file name of the save target data or may be determined with reference to a header of the save target data, for example. Various methods can be adopted as the method of determining the data format.

The CPU 102 refers to the data format information stored in the flash memory 104 to check whether there is information for identifying the online storage associated with the information of the data format obtained as a result of the determination. More specifically, the CPU 102 determines whether there is an online storage that permits the determined data format among the plurality of online storage systems 301 to 303. If there is an online storage that permits the determined data format among the plurality of online storage systems 301 to 303 (step S102; YES), the CPU 102 moves to step S103 to advance the process. If there is no online storage that permits the determined data format among the plurality of online storage systems 301 to 303 in step S102 (step S102; NO), the CPU 102 moves to step S104 to advance the process.

In step S103, the CPU 102 selects the online storage, which permits the data format of the save target data, as the online storage as a save location of the save target data and moves to step S106. If there are a plurality of online storage systems that permit the data format of the data to be saved (online storage systems as save location candidates) in step S103, the CPU 102 may select the online storage as a save location based on one of the following methods.

In an example of the selection method (first method), the CPU 102 randomly selects the online storage as a save location from the plurality of online storage systems as save location candidates. According to the first method, a specific online storage is prevented from being intensively used in contrast to the case where the online storage is selected based on a rule other than the random selection. In general, an upper limit of the storage capacity is set in the online storage, and permitted number of accesses per unit time are limited. Therefore, intensive data saving to a specific online storage is not suitable.

In another example of the selection method (second method), based on the upper capacity information stored in the flash memory 104, the CPU 102 preferentially selects the online storage as a save location, in descending order of the upper limit of the storage capacity, from the plurality of online storage systems as save location candidates. For example, the CPU 102 selects, as the online storage as a save location, the online storage with the largest upper limit of the storage capacity from the plurality of online storage systems as save location candidates. According to the second method, selection can be made to whether to thoroughly consume the online storage with a small upper limit of the storage capacity first or to preferentially use the online storage with a large upper limit so as to collectively save the data in one location as much as possible.

In another selection method (third method), the CPU 102 measures the communication speed for each of the plurality of online storage systems as save location candidates and preferentially selects, as the online storage as a save location, the online storage with a high communication speed from the plurality of online storage systems as save location candidates. For example, the CPU 102 selects, as the online storage as a save location, the online storage with the highest communication speed from the plurality of online storage systems as save location candidates. According to the third method, the process is executed in consideration of the time required to save the data.

Meanwhile, in step S104, the CPU 102 selects an online storage as a save location from the plurality of online storage systems 301 to 303 (online storage systems as save location candidates). The first, second, or third method can be used to select the online storage as a save location from the plurality of online storage systems as save location candidates.

In step S105, the CPU 102 adds, to the save target data, header information indicating the allowable data formats in the online storage as a save location and converts the data format of the save target data to an allowable data format in appearance. For example, to save jpeg data in the online storage 303, the CPU 102 adds, as the header information of the jpeg data, fake information corresponding to an allowable data format in the online storage 303, such as information indicating a data format of one of mail data, docs data, and xls data. When the online storage 303 determines the data format based on the header information, the online storage 303 recognizes the jpeg data as mail data, docs data, or xls data based on the fake information. As a result, the jpeg data can be saved in the online storage 303.

In step S106, the CPU 102 determines whether the user is logging in to the online storage as a save location. If the user is already logging in to the online storage as a save location (step S106; YES), the CPU 102 advances the process to step S108. On the other hand, if the user is not logging in to the online storage as a save location (step S106; NO), the CPU 102 advances the process to step S107.

In step S107, the CPU 102 uses the login information (user ID and password) stored in the flash memory 104 to execute a process of logging in to the online storage as a save location.

In step S108, the CPU 102 reads the URL of the online storage selected as a save location from the online storage information stored in the flash memory 104. The CPU 102 controls the LAN I/F 101 to transmit the save target data to the read URL. In this way, the CPU 102 saves the save target data in the online storage selected as a save location (steps S103 to S108 correspond to the saving step).

In step S109, the CPU 102 associates the information for identifying the save target data with the information for identifying the online storage as a save location and adds the information to the save location information stored in the flash memory 104 to update the save location information (storage step).

An operation of data reading by the NAS 100 from an online storage will be described. FIG. 6 is a flow chart showing an operation of data reading by the NAS 100 from an online storage.

As shown in FIG. 6, the LAN I/F 101 receives the data read request from the PC 200 in step S202. The data read request includes information (for example, may be the file name) for identifying the data to be read (read target data).

In step S202, the CPU 102 accepts the data read request from the LAN I/F 101. The CPU 102 refers to the save location information stored in the flash memory 104 and reads the information for identifying the online storage associated with the information for identifying the read target data. The CPU 102 specifies the online storage identified by the read information from the online storage systems 301 to 303 (specifying step).

In step S203, the CPU 102 determines whether the user is logging in to the online storage specified in step S202. If the CPU 102 determines that the user is logging in to the specified online storage (step S203; YES), the CPU 102 advances the process to step S205. On the other hand, if the user is not logging in to the specified online storage (step S203; NO), the CPU 102 advances the process to step S204.

In step S204, the CPU 102 uses the login information (user ID and password) stored in the flash memory 104 to execute a process of logging in to the online storage specified in step S202.

In step S205, the CPU 102 reads the URL of the online storage specified in step S202 from the online storage information stored in the flash memory 104.

The CPU 102 accesses the online storage that has the read target data based on the read URL to read the read target data. The read target data read out from the online storage is temporarily stored in the RAM 103 (reading step).

If the fake information related to the data format is added to the read data, the CPU 102 removes the fake information. In this way, the CPU 102 restores the data format of the read data.

In step S206, the CPU 102 instructs the LAN I/F 101 to transmit the data temporarily stored in the RAM 103 to the PC 200. In accordance with the instruction, the LAN I/F 101 transmits the read data to the PC 200 as a request source.

As described, the NAS 100 specifies the online storage that has the data requested from the PC 200 based on the save location information indicating an association between the data saved in one of the plurality of online storage systems 301 to 303 and the online storage as a save location of the data. The NAS 100 reads the data from the specified online storage and transmits the data to the PC 200.

As a result, the user who uses the plurality of online storage systems 301 to 303 does not have to be conscious of which online storage the data will be saved or is saved. More specifically, when the user operates the PC 200 to request the NAS 100 for desired data, the NAS 100 acquires and provides the data from the online storage as a storage location. As a result, from the viewpoint of the user, the user can see the plurality of online storage systems 301 to 303 as one storage as a whole.

Even if the allowable data formats in the plurality of online storage systems 301 to 303 are different, the NAS 100 here saves the save target data in the online storage that permits the data format of the save target data. Even if none of the plurality of online storage systems 301 to 303 permits the data format of the save target data, the NAS 100 here processes the save target data so that the data format is identified as an allowable data format in one of the online storage systems. As a result, the save target data can be saved in one of the online storage systems.

A second aspect of the present embodiment will be described.

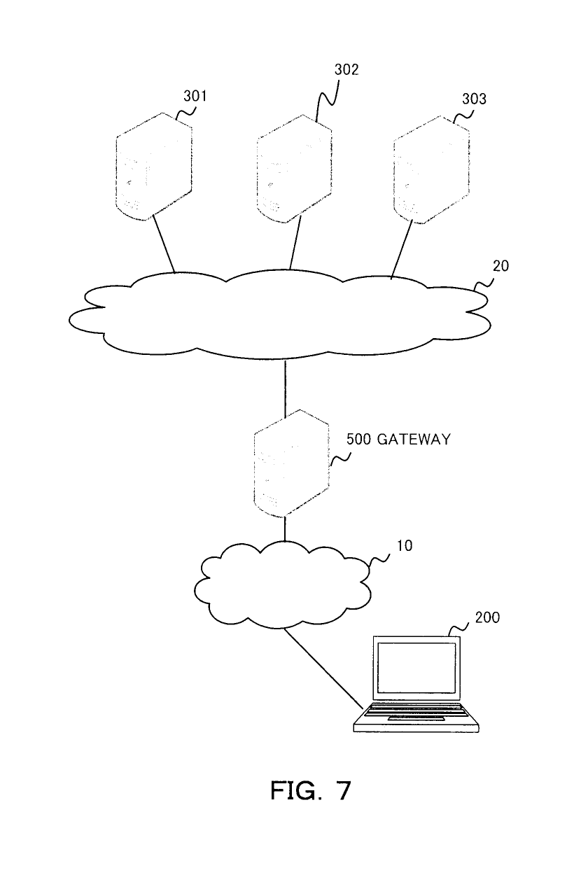

As shown in FIG. 7, the data management system according to the second aspect includes a gateway 500, the PC 200, and the plurality of online storage systems 301 to 303.

The gateway 500 is connected to the LAN 10 and the Internet 20, and the gateway 500 intermediates communication between a device connected to the LAN 10 and a device connected to be able to communicate through the Internet 20. In the aspect, the gateway 500 corresponds to the data management apparatus, and the PC 200 corresponds to the terminal device.

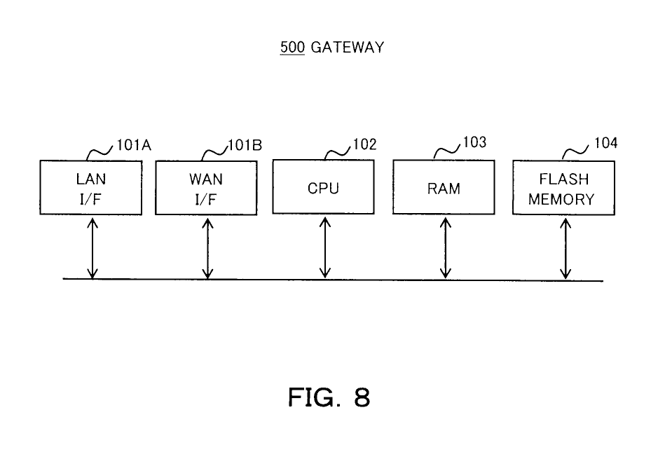

FIG. 8 is a block diagram showing a configuration of the gateway 500.

As shown in FIG. 8, the gateway 500 includes a LAN I/F 101A, a WAN I/F 101B, the CPU 102, the RAM 103, and the flash memory 104.

The LAN I/F 101A outputs data received through the LAN 10 to the CPU 102. In accordance with an instruction input from the CPU 102, the LAN I/F 101A sends instructed data to an instructed address through the LAN 10. The WAN I/F 101B outputs data received through a WAN (the Internet 20) to the CPU 102. In accordance with an instruction input from the CPU 102, the WAN I/F 101B sends instructed data to an instructed address through the WAN (the Internet 20). In the aspect of the present embodiment, the LAN I/F 101A and the WAN I/F 101B correspond to the communication unit that communicates between the plurality of online storage systems 301 to 303 and the PC 200.

The CPU 102, the RAM 103, and the flash memory 104 are the same as in the first aspect. In the second aspect, the CPU 102 functions as the saving unit. The CPU 102 receives a data save request from the PC 200 and saves save target data related to the data save request in one of the plurality of online storage systems 301 to 303. The CPU 102 also functions as the reading unit. When a data read request is received from the PC 200, the CPU 102 reads data from one of the plurality of online storage systems 301 to 303.

In the second aspect, the flash memory 104 stores save location information, which has information for identifying the save target data associated with information for identifying the online storage as a save location of the save target data.

The flash memory 104 stores, for each online storage, data format information indicating allowable data formats and upper capacity information indicating the upper limit of the storage capacity. The flash memory 104 stores, for each online storage, information for identifying the user (user ID) and login information including the password. In this way, the flash memory 104 corresponds to the data format storage unit, the login information storage unit, the upper capacity information storage unit, and the save location storage unit in the second aspect.

An operation of the CPU 102 of the gateway 500 in data saving to the online storage is the same as the operation of data saving by the CPU 102 of the NAS 100 shown in FIG. 5. An operation of the CPU 102 of the gateway 500 in data reading from the online storage is the same as the operation of data reading by the CPU 102 of the NAS 100 shown in FIG. 6.

In this way, the gateway 500 holds the save location information, which has the information for identifying the data saved in one of the plurality of online storage systems 301 to 303 associated with the information for identifying the online storage as a save location of the data in the second aspect. The gateway 500 refers to the save location information to specify the online storage that has the data requested from the PC 200 and reads the requested data from the specified online storage to transmit the data to the PC 200.

As a result, the user who uses the plurality of online storage systems 301 to 303 can just request the gateway 500 for desired data to obtain the data to be read from the gateway 500 without being conscious of which online storage the requested data is stored. Therefore, from the viewpoint of the user, the user can see the plurality of online storage systems 301 to 303 as one storage as a whole.

Although the present invention has been described based on the embodiments, the statements and the drawings that form part of the disclosure should not be construed as limiting the invention. Various alternative embodiments, examples, and operation techniques will become apparent to those skilled in the art from the disclosure.

Although the NAS and the gateway serve as the data management apparatus in the embodiments, the present embodiments are not limited to the NAS and the gateway. An access point, an HDD recorder, and various devices connected to be able to communicate with the online storage systems may serve as the data management apparatus.

In the description above, the data management apparatus receives a request for saving or reading data from the PC 200 or the like as a terminal device through a network. However, the terminal device may operate as the data management apparatus.

The following first, second, and third methods are illustrated as selection methods of the online storage systems in step S103 in the process of data saving by the data management apparatus (FIG. 5).

(1) Method of Random Selection

(2) Method of Selecting in Descending Order of the Upper Limits of the Storage Capacities

(3) Method of Selecting in Descending Order of the Measured Communication Speeds

However, the data management apparatus of the present embodiments may use a combination of the methods. For example, if there are a plurality of online storage systems with the largest upper limit of the storage capacity, an online storage as a save location may be randomly selected from the plurality of online storage systems with the largest upper limit of the storage capacity.

An upper limit value L of the storage capacity and a measured communication speed P may be multiplied by predetermined weights α and β, respectively, to obtain a score valueS=α×L+β×p, and the online storage as a save location may be selected in descending order of the score values.

In the description above, the upper capacity information may be a predetermined value or may be, so to say, a usable remaining capacity that increases and decreases when data is stored or the stored data is deleted. If the remaining capacity serves as the upper capacity information, for example, the CPU 102 that has saved data in the process of FIG. 5 acquires, after saving the data, the information of the upper limit of the storage capacity (decreased as the data is stored) from the online storage as a save location. The CPU 102 then overwrites and updates, with the acquired upper limit, the upper capacity information associated with the information for identifying the online storage as a save location among the pieces of online storage information illustrated in FIG. 3.

When deleting data after receiving an instruction for deleting the data, the CPU 102 deletes the data from the online storage and then acquires the information of the upper limit of the storage capacity (increased as the data is deleted) from the online storage from which the data is deleted.

The CPU 102 overwrites and updates, with the acquired information of the upper limit, the upper capacity information associated with the information for identifying the online storage from which the data is deleted, among the pieces of online storage information illustrated in FIG. 3.

In the process of FIG. 5, if a size D of the data to be saved is greater than Lmax which is the storage capacity of the online storage with the largest upper limit of the storage capacity, the CPU 102 may divide the save target data into plural pieces of data by a predetermined method and may handle the plural pieces of data (by this, the size of each piece of data becomes to be equal to or less than the storage capacity of the online storage systems to store the corresponding piece of data) obtained by the division as the save target data to execute the process shown in FIG. 5.

In this case, the CPU 102 associates plural pieces of data identification information of the plural pieces of data obtained by the division (may be the file names of the divided data) with the information for identifying the data before the division (such as the file name) and holds the information in, for example, the flash memory 104.

If the flash memory 104 holds the information for identifying the plural pieces of data obtained by dividing the data in association with the information for identifying the data to be read when a read request is received, the CPU 102 handles the plural pieces of data obtained by the division as the read target data and executes the processes up to step S205 among the processes shown in FIG. 6. The CPU 102 then concatenates the plural pieces of data read and temporarily stored in the RAM to reproduce the data before the division and obtains the data after the reproduction. The CPU 102 executes the process of step S206 of FIG. 6 and instructs the LAN I/F 101 to transmit the data after the reproduction to the PC 200. In accordance with the instruction, the LAN I/F 101 transmits the data after the reproduction to the PC 200 as a request source.

Although there is one PC as a terminal device in the embodiments, there may be a plurality of PCs. Other than the PC, a video information reproduction apparatus or the like may serve as the terminal device.

Description of Symbols

10 LAN, 20 Internet, 100 NAS, 101 LAN I/F, 101A LAN I/F, 101B WAN I/F, 102 CPU, 103 RAM, 104 flash memory, 105 HDD, 200 PC, 301 to 303 online storage systems, 500 gateway.

### FIG. 1

°INTERNET

301 ONLINE STORAGE

302 ONLINE STORAGE

303 ONLINE STORAGE

### FIG. 2

104 FLASH MEMORY

### FIG. 3

#1 ONLINE STORAGE INFORMATION

#2 ONLINE STORAGE ID

#3 USER ID

#4 PASSWORD

#5 ALLOWABLE DATA FORMAT

#6 UPPER LIMIT CAPACITY

### FIG. 4

#1 SAVE LOCATION INFORMATION

#2 DATA ID (FILE NAME)

#3 SAVE LOCATION ONLINE STORAGE ID

### FIG. 5

S101 RECEIVE DATA SAVE REQUEST

S102 IS THERE ONLINE STORAGE THAT SUPPORTS DATA FORMAT OF DATA TO BE SAVED?

S103 SELECT ONLINE STORAGE AS SAVE LOCATION

S104 SELECT ONLINE STORAGE AS SAVE LOCATION

S105 CONVERT DATA FORMAT OF DATA TO BE SAVED

S106 IS USER LOGGING IN TO ONLINE STORAGE AS SAVE LOCATION?

S107 LOG IN TO ONLINE STORAGE AS SAVE LOCATION

S108 SAVE DATA TO BE SAVED

S109 UPDATE SAVE LOCATION INFORMATION

#1 DATA SAVING

#2 END

### FIG. 6

S201 RECEIVE DATA READ REQUEST

S202 SPECIFY ONLINE STORAGE THAT HAS REQUESTED DATA

S203 IS USER LOGGING IN TO SPECIFIED ONLINE STORAGE?

S204 LOG IN TO SPECIFIED ONLINE STORAGE

S205 READ REQUESTED DATA

S206 TRANSMIT READ DATA

#1 DATA READING

#2 END

### FIG. 7

500 GATEWAY

### FIG. 8

104 FLASH MEMORY

500 GATEWAY

What is claimed is:

1. A data management apparatus comprising:
a communication unit that communicates with a plurality of online storage systems;
a saving unit that initially saves data and then selects an online storage system in which to save the data;
a save location storage unit that stores save location information, the save location information having information for identifying the data saved by the saving unit and for identifying the online storage system; and
a reading unit that refers to the save location information stored in the save location storage unit in response to a read request and specifies the online storage system that has target data of the read request, and reads the target data from the online storage system after being specified by the reading unit.

2. The data management apparatus according to claim 1, further comprising:
a data format storage unit that stores data format information indicating allowable data formats for each of the plurality of online storage systems, wherein
the saving unit determines the data format of the data to be saved, refers to the data format information stored in the data format storage unit, specifies a specified online storage system that allows the data format of the data to be saved from the plurality of online storage systems, selects the specified online storage system, and saves the data to be saved in the specified online storage system.

3. The data management apparatus according to claim 2, wherein
if there is no online storage system that allows the determined data format among the plurality of online storage systems, the saving unit adds to the save target data header information indicating an allowable data format in one of the plurality of online storage systems to covert the data format of the save target data and save the save target data after the data format is converted.

4. The data management apparatus according to claim 1, further comprising:
a login information storage unit that stores login information including a user ID and a password for each of the plurality of online storage systems, wherein
the saving unit and the reading unit use the login information to execute a process of logging into the online storage.

5. The data management apparatus according to claim 1, wherein
if there are a plurality of online storage systems as save location candidates, the saving unit randomly selects a selected online storage system as a save location from the plurality of online storage systems that are save location candidates.

6. The data management apparatus according to claim 1, further comprising:
an upper capacity information storage unit that stores upper capacity information that indicates an upper limit of a storage capacity for each of the plurality of online storage systems, wherein
if there are a plurality of online storage systems as save location candidates, the saving unit refers to the upper capacity information stored in the upper capacity information storage unit and preferentially selects, as the online storage system as a save location with a largest upper limit of the storage capacity from the plurality of online storage systems that are save location candidates.

7. The data management apparatus according to claim 1, further comprising:
a measurement unit that measures a communication speed for each of the plurality of online storage systems, wherein
if there are a plurality of online storage systems as save location candidates, the saving unit is configured to preferentially select, as the at least one of the plurality of online storage systems as a save location, an online storage system with a highest communication speed measured by the measurement unit from the plurality of online storage systems as save location candidates.

8. The data management apparatus according to claim 1, wherein
the saving unit saves at least a portion of the data in at least two of the plurality of online storage systems.

9. A data management method executed in a data management apparatus that communicates with a plurality of online storage systems, the data management method comprising:
selecting with a processing circuit an online storage system from the plurality of online storage systems and initially saving data to be saved in the online storage system;
storing save location information, the save location information having information for identifying the data saved in the saving step and for identifying the online storage system;
referring to the save location information in response to a read request and specifying the online storage system that has target data of the read request; and
reading the target data from the online storage system specified in the specifying step.

10. The data management method according to claim 9, wherein
the storing includes storing data format information indicating allowable data formats for each of the plurality of online storage systems, and
the saving includes determining the data format of the data to be saved, and specifying a specified online storage system that allows the data format of the data to be saved based on the stored data format information, and saving the data in the specified online storage system.

11. The data management method according to claim 10, wherein
the saving includes
adding to the save target data header information indicating an allowable data format if there is no online storage system that permits the determined data format among the plurality of online storage systems to covert the data format of the save target data, and then saving the save target data after conversion.

12. The data management method according to claim 9, wherein
the data management apparatus performs storing login information including a user ID and a password for each of the plurality of online storage systems, and
using the login information in the saving and the reading to execute a process of logging in to the at least one of the plurality of online storage systems.

13. The data management method according to claim 9, wherein
in the saving, if there are a plurality of online storage systems as save location candidates, the online storage system that serves as a save location is randomly selected from the plurality of online storage systems that are save location candidates.

14. The data management method according to claim 9, further comprising:
storing upper capacity information that indicates an upper limit of a storage capacity for each of the plurality of online storage systems, wherein,
if there are a plurality of online storage systems as save location candidates, the upper capacity information is referenced, and an online storage system with the largest upper limit of the storage capacity is selected as the online storage system as a save location, from the plurality of online storage systems that are save location candidates.

15. The data management method according to claim 9, further comprising:
measuring a communication speed for each of the plurality of online storage systems, wherein
if there are a plurality of online storage systems as save location candidates, an online storage system with a highest communication speed is selected as the online storage system as a save location, from among the plurality of online storage systems that are save location candidates.

16. The data management method according to claim 9, wherein
the saving saves at least a portion of the data in at least two of the plurality of online storage systems.

17. A non-transitory computer program storage medium having instructions stored therein that when executed by a processing circuit implements a data management method executed in a data management apparatus enables communicates with a plurality of online storage systems, the method comprising:
selecting with a processing circuit an online storage system from the plurality of online storage systems and initially saving data to be saved in the online storage system;
storing save location information, the save location information having information for identifying the data saved in the saving step and for identifying the online storage system;
referring to the save location information in response to a read request and specifying the online storage system that has target data of the read request; and
reading the target data from the online storage system specified in the specifying step.

18. The computer program storage medium of claim 17, wherein
the storing includes storing data format information indicating allowable data formats for each of the plurality of online storage systems, and
the saving includes determining the data format of the data to be saved, and specifying a specified online storage system that allows the data format of the data to be saved based on the stored data format information, and saving the data in the specified online storage system.

19. The computer program storage medium of claim 18, wherein
the saving includes adding to the save target data header information indicating an allowable data format if there is no online storage system that permits the determined data format among the plurality of online storage systems to covert the data format of the save target data, and then saving the save target data after the conversion.

20. The computer program storage medium of claim 17, wherein
the data management apparatus performs storing login information including a user ID and a password for each of the plurality of online storage systems, and
using the login information in the saving and the reading to execute a process of logging in to the at least one of the plurality of online storage systems.
